(19) United States
(12) Patent Application Publication
(10) Pub. No.: US 2007/0234412 A1
(43) Pub. Date: Oct. 4, 2007

(54) Using a proxy for endpoint access control

(76) Inventors: Ned M. Smith, Beaverton, OR (US); Rajan S. Palanivel, West Orange, NJ (US); Carl G. Klotz JR., Beaverton, OR (US)

Correspondence Address: TROP PRUNER & HU, PC, 1616 S. VOSS ROAD, SUITE 750, HOUSTON, TX, 77057-2631, US

(21) Appl. No.: 11/392,277

(22) Filed: Mar. 29, 2006

(51) Int. Cl. G06F 15/16

(52) U.S. Cl. 726/11

(57) ABSTRACT

A technique includes providing a virtual machine within a first enclave and a second enclave. A virtual machine is used as a proxy to negotiate a connection between the first enclave and the second enclave.

### BACKGROUND

The invention generally relates to using a proxy for endpoint access control.

Due to ever-increasing processing speeds of modern servers, traditional multiple server functions may be consolidated using a virtual environment. In the virtual environment, a virtual machine monitor (VMM) creates virtual machines that are essentially self-contained platforms, as each virtual machine has its own instance of an operating system stack. The virtual machines may therefore, as an example, function as independent servers, while remaining isolated from each other.

Besides increasing server utilization, the virtual environment may be advantageous in other aspects. For example, the virtual machines are isolated from software faults. Therefore, duplicate virtual machines may serve as redundant database servers, with one of the servers being the active server and the other being the backup server. The software isolation that is provided by the virtual environment also thwarts security threats from propagating among the virtual machines.

A particular virtual machine may be part of an enclave, which is set of resources that are protected as a group. As an example, an enclave may be formed from a network, subnet or a group of applications. Communications quite often need to occur between enclaves. For example, a virtual machine may be part of one enclave, and a network over which the virtual machine may communicate data may be part of another enclave.

In general, enclaves typically are mutually suspicious of each other, due to the possibility of malware or malicious activity propagating between the enclaves. Thus, when a connection between enclaves is to occur, each enclave ideally needs a way to investigate claims of policy compliance of the other enclave while maintaining a protective barrier from malware and malicious activity that originates from the other enclave.

### BRIEF DESCRIPTION OF THE DRAWING

FIG. 1 is an illustration of an environment that includes a mutually trusted proxy to negotiate connectivity between two enclaves according to an embodiment of the invention.

FIG. 2 depicts a more detailed representation of the enclaves of FIG. 1 according to an embodiment of the invention.

FIG. 3 is a more detailed schematic diagram of the platform of FIG. 2 according to an embodiment of the invention.

### DETAILED DESCRIPTION

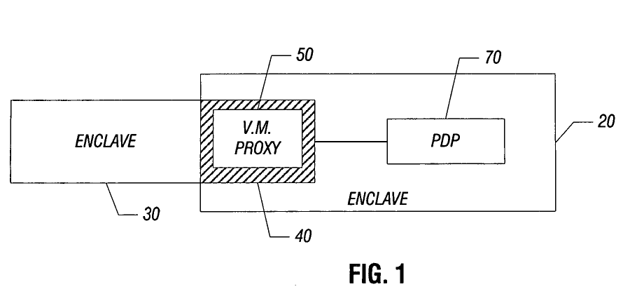

Referring to FIG. 1, in accordance with some embodiments of the invention, a virtual machine-based proxy 50 is used as a trusted intermediary for negotiations between enclaves 20 and 30. As depicted in FIG. 1, the proxy 50 resides in an area 40 of overlapping trust between the enclaves 20 and 30.

As an example, the enclave 20 may include a network, and a virtual machine of the enclave 30 may desire to communicate with the network. For purposes of allowing the virtual machine to connect to the network, the enclave 30 must become trusted to some degree by the enclave 20. This trust may be achieved by the enclave 30 furnishing integrity, or posture, data to the enclave 20. For example, the posture data may indicate the software versions, patch levels and/or virus definition files used by the enclave 30. Based on the posture data, a verifier for the enclave 20, such as a policy decision point (PDP) 70, may then either allow the enclave 30 to connect to the enclave 20, may refuse the connection or may direct the enclave 30 to a particular server or engine to download updated files, for example. A consequence of the access control decision is that the data channel that is used to carry subsequent data may be provisioned by the PDP 70. For example, packet filter rules may be applied to the data channel or a pre-master key (PMK) may be negotiated from which the data channel may be integrity and confidentiality protected.

The above-described generalized scheme of obtaining trust between the enclaves 30 and 20 is a type of endpoint access control (EAC), a control that includes the authentication of an endpoint and the reporting of the integrity state of the endpoint.

In accordance with embodiments of the invention, EAC capabilities may be applied to multi-core, many-core and virtual-machine architectures containing multiple virtual machines and hybrids involving variations of these. Furthermore, EAC may be extended to incorporate I/O controllers connected to platform processor via buses and serial channels where network access decisions based on I/O controller identity and state may be incorporated into an decision and where a consequence of that decision may result in the provisioning and control of resources under the direct control of the authenticated processors, controllers and virtual machines.

As described further below, the enclave 30 may include a host platform (a portable computer, desktop computer, server, personal digital assistant (PDA) or a cellular telephone, as just a few examples) that establishes a virtual environment, which includes the virtual machine proxy 50. In the context of this application, a single instance of a virtual environment exists in an “address space,” a space that includes memory, firmware and processor resources that may be accessed by a processing core.

An address space may also have one or more of the following properties. Each address space may establish a unique identity which will be used for multiple cryptographic operations and protocols performed by each address space; and each address space may be configured with a unique set of security credentials, relating to, but not limited by, the inner authentication methods to be used by each core. The “host” core is provisioned with additional credentials for outer methods, as well. The identities established for each address space are bound into the credentials, and also into the keys which are derived from the inner methods.

All these identities, for each address space, are cryptographically bound together to attest that all the attested address spaces (and, their identities), belong to the same platform.

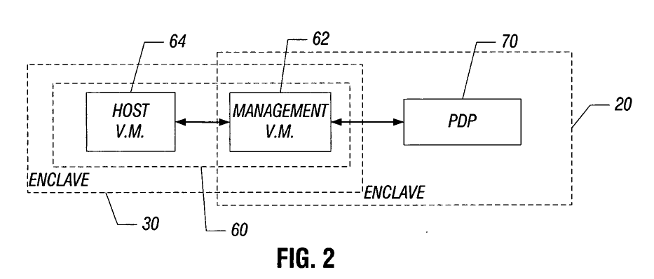

Referring to FIG. 2, in accordance with some embodiments of the invention, the virtual machine proxy 50 (FIG. 1) is a management virtual machine (MVM) 62 that is trusted by both enclaves 20 and 30. The MVM 62 and a host virtual machine (HVM) 64 are part of a virtual environment that is created by a host platform 60. As depicted in FIG. 2, the host platform 60 is part of the enclave 30, and the MVM 62 is part of both enclaves 20 and 30.

Because the MVM 62 serves as a proxy that is physically resident in the host platform 60, the MVM 62 is able to validate the existence and composition of its own components as well as the components of the HVM 64. The MVM 62 represents the HVM 64 on the HVM's behalf through proxy services that provide high degree of data and protocol transparency, while making the client endpoint clearly authenticated and hardened against malware.

In accordance with some embodiments of the invention, the MVM 62 functions as a server for the HVM 64 and functions as a client for the PDP 70. As a more specific example, in accordance with some embodiments of the invention, the MVM 62 establishes a virtual network connection for the HVM 64.

In other words, in accordance with some embodiments of the invention, the MVM 62 may establish certain standards before allowing the HVM 64 to connect to the network. For example, the MVM 62 may require that the HVM 64 may have certain firewall and virus software versions, definition files, patch levels, etc. If the HVM 64 meets these criteria, then the management virtual machine 62 connects the host virtual machine 64 to the virtual network.

At the time of connection of the HVM 64 to the network, the MVM 62 may not be connected to the network, as the management virtual machine's connection to the network is subject to EAC-based negotiation between the MVM 62 and the enclave 20. In the interim of establishing this connection or if the MVM 62 cannot establish the connection, the MVM 62 may furnish cached pages to the HVM 64, as the HVM 64 is unaware of the physical connection status.

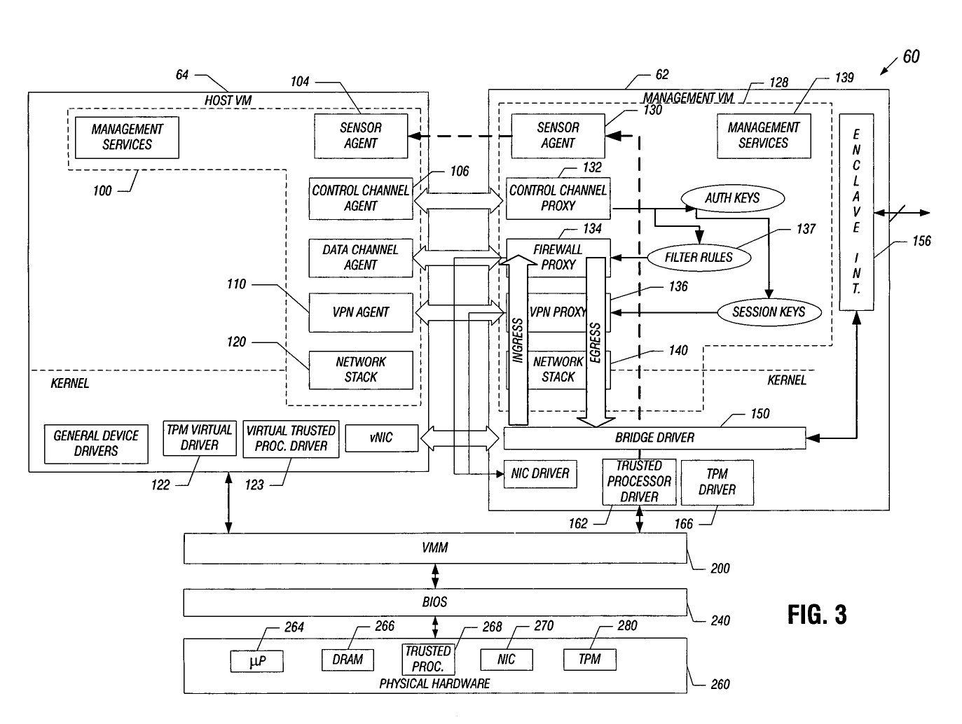

Referring to FIG. 3, in accordance with some embodiments of the invention, the platform 60 may include physical hardware 260 that includes, among other components, a microprocessor 264, a dynamic random access memory (DRAM) 266, a trusted processor 268, a network interface card (NIC) 270, and a trusted platform module (TPM) 280. The microprocessor 264 executes program instructions (that may be stored in the DRAM 266) for purposes of establishing various software layers of the platform 60, further discussed below. The trusted processor 268 may be a microcontroller or microprocessor whose sole function is to gather posture data for the platform, in accordance with some embodiments of the invention. The NIC 270 physically connects the platform 60 to an external network, and the TPM 280 stores secure information, such as posture data. The TPM 280 may comply with the standards for a TPM, which are set forth in the specification entitled, “TCG TPM Specification,” version 1.2, level 1, dated Jan. 6, 2006, which is available from the Trusted Computing Group (TCG), 5440 S.W. Westgate Drive, Ste. 217, Portland, Oreg. 97221 and available on the Internet at www.trustedcomputinggroup.org.

As also depicted in FIG. 3, the platform 60 also includes a basic input/output system (BIOS) 240 and a virtual machine monitor (VMM) 200. The purpose of the VMM 200 is to abstract the physical hardware 260 and BIOS 240 so that each virtual machine is not tied to specific hardware resources. The VMM 200 loads the HVM 64 and the MVM 62 and hosts operating systems for these virtual machines.

As noted above, in accordance with some embodiments of the invention, the MVM 62 functions as a server to the HVM 64. In this function, the MVM 62 includes an interface 128. The HVM 64, in turn, functions as a client and includes a client interface 100. The management virtual machine 62 may also include an enclave interface 156 that functions as a client to the enclave and may have a similar design to the interface 100 of the host virtual machine 64, in accordance with some embodiments of the invention.

Referring to FIG. 3 in conjunction with FIG. 2, physical resources are protected through isolation behind the MVM 62 and by integrity monitoring agents, or sensors, which are contained in the physical hardware 260 (such as the trusted processor 268, in the BIOS 240 and in both VMs 62 and 64). More specifically, a hardware rooted integrity sensor that is exposed by a trusted processor driver 162 monitors a sensor agent 130 of the MVM 62, which, in turn, monitors a sensor agent 104 of the HVM 64. Each of these sensor agents collects integrity values of other components within its virtual machine domain. Integrity values are reported through a control channel to the PDP 70 (see FIG. 2). A control channel agent 106 of the HVM 64 reports HVM sensor data to a control channel proxy 132 of the MVM 62. The control channel proxy 132 may forward the data to the PDP 70 (for example), which may evaluate and aggregate some of the sensor data and report only the result, in accordance with some embodiments of the invention.

The control channel proxy 132 accepts an access control decision from the PDP 70 (see FIG. 2). A suitable access control rule is selected from a set of pre-provisioned filter rules 137. Alternatively, a suitable access control rule may be directly provisioned by the PDP 70 or a regional manageability console. The control channel proxy 132 establishes an authentication session between the HVM 64 and itself and another authentication session between itself and the PDP 70. The control channel agent 106 may be unaware of the proxy that is established by the MVM 62 but may be configured to accept the MVM authentication credentials as part of a customer-specified policy. The code for the host control channel agent 106 may not require recompilation.

The proxy relationship between HVM 64 and MVM 62 means authentication protocols may not use encryption, in accordance with some embodiments of the invention. A simple and ubiquitous authentication protocol may therefore be used in these embodiments of the invention. For the authentication between the MVM 62 and the PDP 70, an EAP tunnel protocol with bi-lateral authentication may be used, in accordance with some embodiments of the invention. From the PDP's perspective, the MVM 62 is the authoritative endpoint, as the sensor agent 130 can report the integrity state of both the MVM 62 and the HVM 64. The architecture of the MVM 62 establishes a neutral zone that is protected from host-based attacks/vulnerabilities, and the MVM 62 also isolates the HVM 64 from networks that may be the source of worms and viruses that are targeted at the host.

The sensor agent 104 of the HVM 64 may seek to establish for itself the trustworthy configuration and operation of the MVM 62. This can be achieved, for example, through a virtualized driver 122 for the TPM 280. The driver 122 exposes a reporting interface to the TPM 280, which allows the HVM 64 to view integrity measurements that are taken of the MVM 62. Additionally, the driver 123 obtains activity logs that are generated by the trusted processor 268, which pertain to health of the sensor agent 130 of the MVM 62. Activity log file integrity may be preserved using a TPM processor control register (PCR), which may be accessed directly through hardware or indirectly through the VMM 200. Activity logs and load-time integrity measurements in the TPM PCRs are evaluated by the HVM 64 to establish trust in the MVM 62. The sensor agent 130 discloses the detailed data that is provided by the sensor agent 104 about MVM operation to the HVM sensor agent 104 directly. The sensor agent 104 is able to establish the veracity of the MVM measurement data by verifying activity logs and PCR values.

Sensor data may be aggregated by the collector or reporting components. Aggregation has the effect of stripping extraneous data from the data set, which can be beneficial for privacy policies that restrict disclosure of personal and personally identifiable information. In addition to aggregation, reporting functions may apply localized policies that report only that a particular policy has been applied.

In accordance with some embodiments of the invention, the access control rules are installed in a firewall proxy 134 in the MVM 62 by the control channel proxy 132 or by a management service 139 (both TPM and MVM management services are part of the management services 139 in FIG. 3). The firewall proxy 134 is an application or driver that is in the data path of the HVM 64. The firewall proxy 134 applies filtering logic to data frames flowing over any of the network interfaces controlled by the MVM 62. Data frames from the HVM 64 are routed through the firewall proxy 134 to ensure proper filtering is applied. The filter rules 137 may deny all packets or rate limit based on a denial of service attached signature from the firewall proxy 134.

Layer two and layer three filter rules may be applied by the physical hardware 260 or a driver for the hardware 260 before source and destination information is stripped off by ingress or egress through a network stack 140 of the MVM 62. In the case where the data channel is encrypted, a virtual private network (VPN) proxy 136 of the MVM 62 performs the decryption prior to passing the frame to the firewall proxy 134 for evaluation. The encryption/decryption engine may be layered beneath the filtering engines whenever both protection mechanisms are employed together.

The VPN proxy 136 establishes a connection between itself and the HVM 64 and another connection between itself and a remote enclave. The VPN proxy 136 allows applications in the HVM 64 to interface with a VPN agent 110 of the HVM 64 transparently without requiring code modifications. The VPN proxy 136 exposes HVM packets to the network filter prior to re-encryption over the outside facing VPN. The VPN proxy 136 may implement VPNs at different network layers accommodating many possible network connection scenarios, while enforcing a consistent access control posture from the MVM 62.

The session keys for encryption/decryption are created by the VPN proxy 136 under the control of the control channel proxy 132. In some embodiments of the invention, distinct sets of session keys are created, one set for HVM-to-MVM interactions and another for MVM-to-the enclave 20 interactions. The session keys are derived from an authentication protocol implemented by the control channel proxy 132. Authentication keys are provisioned by a management service 139.

Agents in the HVM 64 may obtain authentication keys from the TPM 280 via a virtual TPM driver 122. The virtual TPM driver 122 communicates with a bridge driver 150 of the MVM 62, which, in turn, vectors calls to a TPM management service 139. The TPM management service 139 via a TPM driver 166 accesses the TPM 280 to read authentication keys. The HVM 64 is guaranteed to find a suitable trust anchor (public authentication key) for the other end of its VPN endpoint, the VPN proxy 136, because the MVM Management Service 139 may provision the trust anchor as needed.

In other embodiments of the invention, a physical driver for the TPM 280 in which the VMM 200 has virtualized the TPM 280 directly may be used. In these embodiments of the invention, no communications may be required between the VM partitions, and the TPM management service 139 is actually in the VMM 200.

The management services 139 in conjunction with the trusted processor 268 may configure the policies of the VPN agent 110 such that the agent 110 communicates with the VPN proxy 136 and the other MVM proxy engines to minimize overhead. For example, there may be no reason to encrypt packets between the HVM 64 and MVM 62 due to the closed communication channel via the VMM 200. The VPN proxy 136 however must not break given an unmodified vanilla configuration. Although the resulting VPN may encrypt unnecessarily, the goals of transparency can be met.

The network stack 140 of the MVM 62 performs a dual role of stripping a network layer encapsulation applied by the HVM 64 on ingress and applies the appropriate network encapsulation for egress to the outside network. A network stack 120 of the HVM 64 may cooperate with the network stack 140 of the MVM 62, in accordance with some embodiments of the invention, to select the most efficient encoding given the point-to-point relationship. They could for example share a single IP address having out of band knowledge of each other as endpoints. They could choose not to apply any network layer encapsulation at all to improve throughput.

A bridge driver 150 of the MVM 62 serves as an interface redirector that routes driver access “upward” to an appropriate service or proxy, or “downward” to a physical driver in cases where virtualization of the request is not needed.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A method comprising:
providing a virtual machine within a first enclave and a second enclave; and
using the virtual machine as a proxy to negotiate a connection between the first enclave and the second enclave.

2. The method of claim 1, wherein using the proxy to function as a server with respect to the first enclave and using the proxy to function as a client with respect to the second enclave.

3. The method of claim 1, wherein the act of using the virtual machine as a proxy comprises establishing a virtual network connection for the first enclave.

4. The method of claim 1, wherein the virtual machine comprises a management virtual machine.

5. The method of claim 1, further comprising:
providing a platform that is part of the first enclave; and
executing software on the platform to provide the virtual machine.

6. The method of claim 1, wherein the virtual machine comprises a first virtual machine, the method further comprising:
providing a platform that is part of the first enclave;
executing software on the platform to provide a second virtual machine; and
using the first virtual machine as a proxy for the second virtual machine for connection to the second enclave.

7. An apparatus comprising:
a first virtual machine of a first enclave to be a proxy between a second virtual machine of the first enclave and a second enclave different from the first enclave.

8. The apparatus of claim 7, wherein the first virtual machine is part of the first enclave and the second enclave.

9. The apparatus of claim 7, wherein the first virtual machine comprises:
a control channel proxy to establish a first authentication session between the first virtual machine and the second virtual machine and a second authentication session between the first virtual machine and a policy decision point of the second enclave.

10. The apparatus of claim 7, wherein the first virtual machine comprises:
a virtual private network proxy to establish a first connection between the first virtual network and the second virtual machine and a second connection between the first virtual machine and a virtual private network of the second enclave.

11. The apparatus of claim 7, wherein the first virtual machine comprises:
a firewall proxy to filter data provided by the second virtual machine for communication to the second enclave.

12. The apparatus of claim 7, wherein the first virtual machine is a client for the second enclave and a server for the second virtual machine.

13. An article comprising a computer accessible storage medium storing instructions that, when executed by a computer, cause the computer to:
provide a virtual machine within a first enclave and a second enclave; and
use the virtual machine as a proxy to negotiate a connection between the first enclave and the second enclave.

14. The article of claim 13, the storage medium storing instructions to cause the computer to cause the proxy to function as a server with respect to the first enclave and a client with respect to the second enclave.

15. The article of claim 13, the storage medium storing instructions to cause the computer to establish a virtual network connection for the first enclave.

16. The article of claim 13, the storage medium storing instructions to cause the computer to establish another virtual machine of the first enclave and not of the second enclave to use the proxy to negotiate a connection with the second enclave machine.

17.-21. (canceled)

22. The apparatus of claim 7, further comprising:
trusted hardware to be used by the second virtual machine to establish trust of the first virtual machine to act as a proxy for the second virtual machine.

23. The apparatus of claim 7, further comprising:
trusted hardware to be used by a policy decision point to establish trust of the first virtual machine.

24. The method of claim 1, wherein the first enclave comprises a set of resources protected as a group.

25. The apparatus of claim 7, wherein the first enclave comprises a set of resources protected as a group.
